(19) United States
(12) Patent Application Publication
(10) Pub. No.: US 2006/0004880 A1
(43) Pub. Date: Jan. 5, 2006

(54) Data-updating method for embedded system

(75) Inventors: Wen-Ruei Chen, Hsinchu (TW); Yun-Cheng Lin, Hsinchu (TW)

Correspondence Address: EDWARDS & ANGELL, LLP, P.O. BOX 55874, BOSTON, MA, 02205, US

(73) Assignee: RDC Semiconductor Co., Ltd., Hsin Chu (TW)

(21) Appl. No.: 11/099,721

(22) Filed: Apr. 5, 2005

(30) Foreign Application Priority Data
May 5, 2004 (TW) 093112612

(51) Int. Cl. G06F 12/00

(52) U.S. Cl. 707/200

(57) ABSTRACT

A data-updating method for an embedded system capable of coupling with a network communication apparatus is provided. The embedded system containing data to be updated is searched through a network by the network communication apparatus using network resources. Networking data stored in the embedded system is accessed by the network communication apparatus which is subsequently linked to a corresponding network resource location using the networking data. Then, the data within the network resource location is modified, updated or downloaded using the network communication apparatus. The modified, updated, or downloaded data is then stored in a storage unit of the network communication apparatus using the network communication apparatus. Lastly, the data of the embedded system is updated in a conventional file updating manner using the network communication apparatus. Therefore, the data-updating method for the embedded system proposed in the present invention allows users to intuitively update the data of the embedded system using common sense.

### FIELD OF THE INVENTION

The present invention relates to a data-updating method for an embedded system, and more particularly, to a data-updating method applicable to an embedded system having a networking function.

### BACKGROUND OF THE INVENTION

Along with the development of electronic information technology, many newly developed electronic data-processing devices or systems such as personal computers, laptops, servers or work stations are gradually becoming multi-functional and highly efficient. Many devices or systems capable of processing data are also becoming miniaturized as a result of improved manufacturing of electronic information products. Such miniaturized devices or systems can be combined with products incapable of processing data to facilitate the product to gain a data-processing function, such that the product is characterized with artificial intelligence and multi-functions.

For example, a so-called “embedded system” relates to devices used for controlling, monitoring, or assisting equipment, machinery or factory operations. Also, the embedded system relates to a specific computer system which is based on the particular application, computer technology, and software/hardware clipping and applicable to systems having stringent criteria in terms of functionality, reliability, costs, size and power. Such embedded system is characterized with the following features:
1. It usually performs specific functions and significantly differs from general office equipment and database serving systems.
2. A core is constituted by a micro-computer with peripherals, having a computational scale ranging from an 8051 single chip system to an advanced x86 chip system.
3. It has stringent criteria in terms of sequence and stability because an accident may occur if a machine is not controlled properly.
4. It is characterized with automatic operation, such that an operational state can be recovered after the power is restored.

The embedded system almost comprehends all micro-computer control devices applicable to fields of automobiles and trucks, airplanes, trains, spacecraft, machine tools, cameras, consumer goods, office equipment, cell phones, personal digital assistants (PDA) and other hand-held products as well as fields of robotics and toys.

Currently, the foregoing embedded system can be operated in the form of a single unit and applied to network architecture in combination with other data-processing systems to tranceive data, such that distant surveillance or operation can be further performed. However, system size has to be considered as the embedded system needs to be embedded into a specific object such as the one of the foregoing vehicles or a PDA. As the size of the object gets smaller, the usefulness gets greater. Relatively speaking, the cost also increases as the size reduces. For the cost to be minimized, specifications and functionality of some of the components have to be downgraded. Thus, for example, if a memory unit or storage device with a smaller size is used to minimize the cost, the working capacity and efficiency of the embedded system will be reduced as a consequence.

However, the major drawback of such an embedded system is that it is very inconvenient for a user, especially for a user who is not a professional in information technology, to update data such as system versions, driving programs, application programs, parameter settings and/or personal data settings. The user normally has to fully understand file settings or other related parameter data such as the internet protocols (IP) and complex operation procedures to update data. Therefore, data often has to be updated by an expert in manufacturing or service centers. This drawback reduces the user's willingness to update data, so that the functionality of such an embedded system cannot be further upgraded and ineffective operation of embedded system results as a consequence.

Accordingly, what is needed, therefore, is a way to provide an effective and easy data-updating method for an embedded system.

### SUMMARY OF THE INVENTION

In light of the above prior-art drawbacks, a primary objective of the present invention is to provide a data-updating method for an embedded system, by which users can easily update data of the embedded system using a simple data-updating method via a network communication apparatus.

Another objective of the present invention is to provide a data-updating method for an embedded system, by which users can access updated data of the embedded system via a network communication apparatus.

In accordance with the above and other objectives, the present invention proposes a data-updating method for an embedded system capable of coupling with a network communication apparatus. First, the embedded system containing data to be updated is searched through a network by the network communication apparatus using network resources. Networking data stored in the embedded system is accessed by the network communication apparatus which is subsequently linked to a corresponding network resource location using the networking data. Then, the data is modified, updated, or downloaded within the network resource location by the network communication apparatus. The modified, updated, or downloaded data is then stored in a storage unit of the network communication apparatus. Finally, the data of the embedded system is updated in a conventional file updating manner by the network communication apparatus.

In comparison to the prior-art data-updating method of an embedded system, the data-updating method for the embedded system proposed in the present invention allows the user to intuitively update the data of the embedded system using only common sense instead of specialized knowledge or experience.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing the system architecture of a data-updating method for an embedded system according to the present invention; and

FIG. 2 is a flowchart showing the steps of operation for the data-updating method for an embedded system according to the present invention.

### DETAILED DESCRIPTION OF THE EMBODIMENTS

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

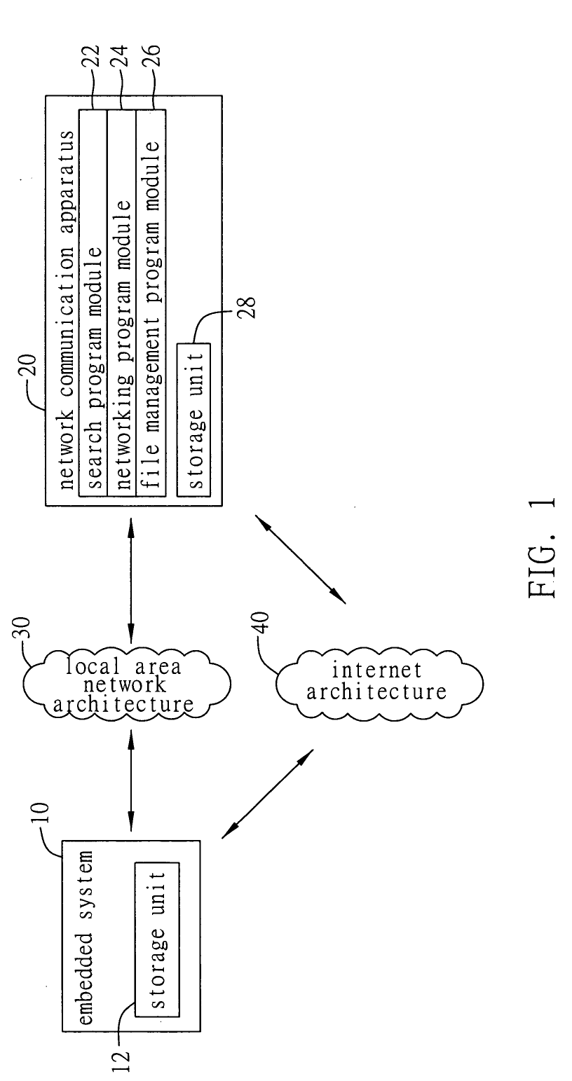

FIG. 1 is a schematic diagram showing the system architecture of a data-updating method for an embedded system according to the present invention. Referring to FIG. 1, an embedded system 10, a network communication apparatus 20, local area network architecture 30, and internet architecture 40 are comprised and depicted as related in the invention of the current embodiment.

In the present embodiment, the embedded system 10 is a conventional set top box device utilizing an embedded system. The embedded system 10 needs to have networking and communication functions, such that data can be accessed, transmitted or communicated with other communication apparatuses within network communication architecture via the network communication architecture. The embedded system 10 also comprises a storage unit 12 for storing data related to operation or execution of the embedded system 10. In the present embodiment, such data includes data of network resource locations, system operation, and etc.

In the present embodiment, the network communication apparatus 20 is a personal computer having a network communication function. The architecture and software/hardware functions are known in the prior art and therefore are not further described. The network communication apparatus 20 comprises at least a search program module 22 such as one provided by the Microsoft Windows operating system for searching a network apparatus, a networking program module 24 such as Microsoft Internet Explorer (IE) for browsing and downloading data, and a file management program module 26 such as one provided by the Microsoft Windows operating system for managing files. Additionally, the network communication apparatus 20 further comprises a storage unit 28 for storing downloaded data.

In the present embodiment, the local area network architecture 30 provides a network communication environment which interlinks the embedded system 10 and the network communication apparatus 20 for accessing, transmitting or communicating the data. The local area network architecture can be implemented in a wired or wireless form, which are already described in the prior art and, therefore, is not further described.

In the present invention, the internet architecture 40 is a conventional internet communication architecture which serves to link the network communication apparatus 20 to a network resource location of an internet, so as to access, transmit or communicate the data from the network resource. The internet architecture 40 can be replaced by an intranet or extranet.

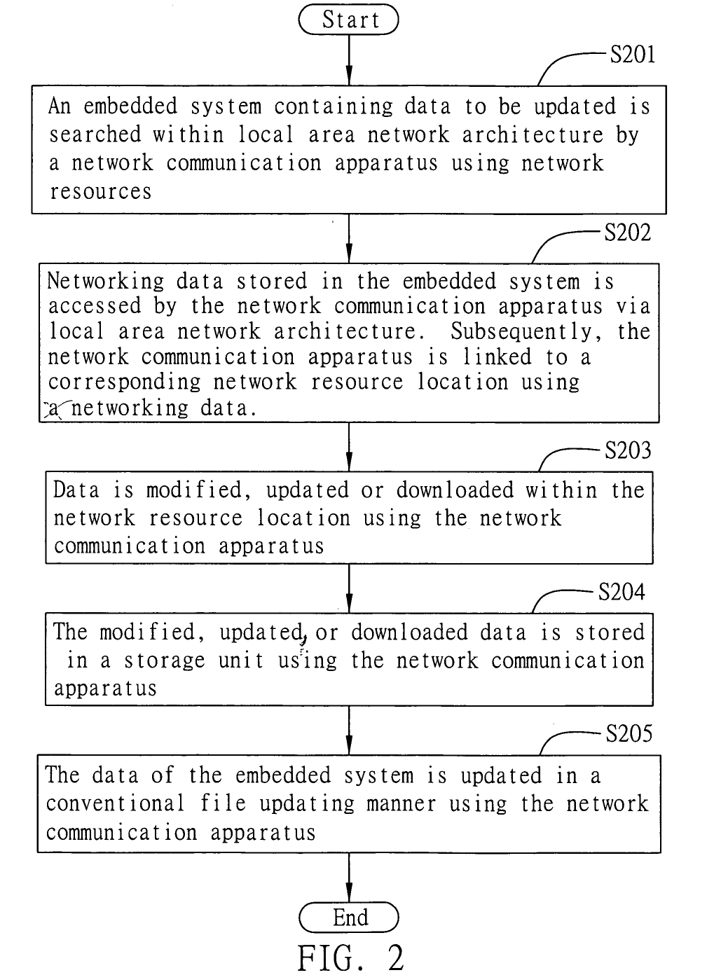

Before applying the data-updating method proposed in the present invention to an embedded system using the foregoing application system architecture, it needs to be confirmed that the embedded system 10 and the network communication apparatus 20 have been successfully linked to the local area network architecture 30 and that the network communication apparatus 20 has been successfully linked to the internet architecture 40. FIG. 2 shows the steps of operation for the data-updating method for the embedded system according to the present invention.

Referring to Step S201, the embedded system 10 containing data to be updated is searched within the local area network architecture 30 by the network communication apparatus 20 using the network resource. As previously mentioned, in the present invention, a location of the embedded system 10 is searched by the network communication apparatus 20 using the search program module 22. Then, the network communication apparatus 20 is linked to the embedded system 10 via the local area network architecture 30.

Referring to Step S202, the networking data stored in the embedded system 10 is accessed by the network communication apparatus 20 via the local area network architecture 30. Subsequently, the network communication apparatus 20 is linked to a corresponding network resource location using the networking program module 24 via the internet architecture 40 according to the networking data. As previously mentioned, in the present invention, the data related to the operation and execution of the embedded system 10 is stored in the storage unit 12, wherein the data includes the data of network resource locations and operating systems. Thus, once the network communication apparatus 20 is linked to the embedded system 10 via the local area network architecture 30, the network communication apparatus 20 is able to gain the network resource location of updating data provided by manufactures of the embedded system 10 by accessing a folder of the storage unit 12. Then, the embedded system 10 can be linked to a webpage corresponding to the network resource location via the internet architecture 40 using a shortcut or superlink.

Referring to Step S203, the data is modified, updated, or downloaded within the network resource location using the network communication apparatus 20. As mentioned previously, in the present invention, the network resource location provides an interface for the user to modify, update or download the data, such that the data is updated and/or modified on the network using the network communication apparatus 20 and an updated version of operation system can also be downloaded.

Referring to Step S204, the modified, updated or downloaded data is stored in the storage unit 28 using the network communication apparatus 20.

As previously mentioned, in the present invention, after the data of the updated version of operation system is downloaded by the network communication apparatus 20, the downloaded data is stored in the storage unit 28.

Referring to Step S205, the data of the embedded system 10 is updated in a conventional file updating manner using the network communication apparatus 20. As previously mentioned, the network communication apparatus 20 is linked to the embedded system 10 via the local area network architecture 30. The user can duplicate or shift the data of the updated version of operation system from the storage unit 28 to the folder of the storage unit 12 using “copy”, “cut” and “paste” functions. Thus, updating of the version of the operation system for the embedded system 10 is completed.

The invention has been described using exemplary preferred embodiments. However, it is to be understood that the scope of the invention is not limited to the disclosed embodiments. On the contrary, it is intended to cover various modifications and similar arrangements. For example, the embedded system 10 can be directly linked to the network communication apparatus 20 via the internet architecture 40, but not via the local area network architecture 30, for the accessing, transmitting or communicating the data. The scope of the claims, therefore, should be accorded the broadest interpretation so as to encompass all such modifications and similar arrangements.

What is claimed is:

1. A data-updating method for an embedded system coupling to a network communication apparatus, the method comprising steps of:
searching the embedded system containing data to be updated via a network by the network communication apparatus using network resources;
accessing networking data stored in a storage unit of the embedded system using the network communication apparatus which is subsequently linked to a corresponding network resource location according to the networking data;
modifying, updating, or downloading data within the network resource location using the network communication apparatus;
storing the modified, updated, or downloaded data in a storage unit of the network communication apparatus using the network communication apparatus; and
updating the networking data stored in the storage unit of the embedded system in a conventional file updating manner by the network communication apparatus.

2. The method of claim 1, wherein the network communication apparatus is linked to the embedded system via a local area network.

3. The method of claim 2, wherein the local area network can be a wired- or a wireless-network.

4. The method of claim 1, wherein the network communication apparatus is linked to the corresponding network resource location via an internet, intranet, or extranet.

5. The method of claim 1, wherein the conventional file updating manner can be methods of copying, shifting and/or replacing data and/or files.

6. A data-updating method for an embedded system coupling to a network communication apparatus, the method comprising steps of:
modifying, updating, or downloading data of the embedded system within a network resource location using the network communication apparatus;
storing the modified, updated or downloaded data in a storage unit of the network communication apparatus using the network communication apparatus; and
updating the data stored in the storage unit of the embedded system in a conventional file updating manner using the network communication apparatus.

7. The method of claim 6, prior to the step of modifying, updating or downloading the data of the embedded system within the network resource location using the network communication apparatus, further comprising the steps of:
searching the embedded system containing data to be updated via a network by the network communication apparatus using network resources; and
accessing networking data stored in the storage unit of the embedded system using the network communication apparatus and linking the network communication apparatus to the corresponding network resource location.

8. The method of claim 6, wherein the network communication apparatus is linked to the embedded system via a local area network.

9. The method of claim 8, wherein the local area network can be a wired- or a wireless-network.

10. The method of claim 6, wherein the network communication apparatus is linked to the corresponding network resource location via an internet, intranet, or extranet.

11. The method of claim 6, wherein the conventional file updating manner can be methods of copying, shifting and/or replacing data and/or files.
